(19) United States
(12) Patent Application Publication
(10) Pub. No.: US 2021/0041774 A1
(43) Pub. Date: Feb. 11, 2021

(54) IMAGE DISPLAY UNIT AND PROJECTOR

(71) Applicant: SONY CORPORATION, TOKYO (JP)

(72) Inventors: YOHEI FUKUMA, CHIBA (JP); YASUO KAWABATA, KANAGAWA (JP); TORU NAGARA, TOKYO (JP)

(21) Appl. No.: 16/964,591

(22) PCT Filed: Jan. 9, 2019
(86) PCT No.: PCT/JP2019/000289

§ 371 Date: Jul. 23, 2020

(30) Foreign Application Priority Data
Feb. 7, 2018 (JP) 2018-019804

(51) Int. Cl. G03B 21/14; G03B 21/00

(52) U.S. Cl. CPC G03B 21/142; G03B 21/006

(57) ABSTRACT

An image display unit according to an embodiment of the present technology includes an image display device, a primary shaft portion, a holding portion, a first acting portion, and a second acting portion. The primary shaft portion extends in a direction. The holding portion holds the image display device, and is connected to the primary shaft portion to be movable in parallel with the direction in which the primary shaft portion extends. The first acting portion is capable of moving the holding portion in a first direction extending in parallel with the direction in which the primary shaft portion extends. The second acting portion is capable of moving the holding portion in a second direction that is opposite to the first direction extending in parallel with the direction in which the primary shaft portion extends.

### TECHNICAL FIELD

The present technology relates to an image display unit that is applicable to, for example, a projector, and the projector.

### BACKGROUND ART

Patent Literature 1 discloses a pixel shift method for improving the definition of an image by moving an image display device such as a liquid crystal panel at a high speed by a distance smaller than a pixel pitch, and discloses a technology intended to accurately move the image display element at a high speed in a parallel manner (For example, paragraphs [0009] and [0041] to [0057] of the specification, and FIGS. 2 to 11 in Patent Literature 1).

### CITATION LIST

### Patent Literature

Patent Literature 1: Japanese Patent Application Laid-open No. 2001-350196

### DISCLOSURE OF INVENTION

### Technical Problem

With respect to such a pixel shift method, there is a need for a technology that makes it possible to stably control the movement of an image display device with a high degree of accuracy.

In view of the circumstances described above, it is an object of the present technology to provide an image display unit and a projector that make it possible to stably control the movement of an image display device with a high degree of accuracy.

### Solution to Problem

In order to achieve the object described above, an image display unit according to an embodiment of the present technology includes an image display device, a primary shaft portion, a holding portion, a first acting portion, and a second acting portion.

The primary shaft portion extends in a direction.

The holding portion holds the image display device, and is connected to the primary shaft portion to be movable in parallel with the direction in which the primary shaft portion extends.

The first acting portion is capable of moving the holding portion in a first direction extending in parallel with the direction in which the primary shaft portion extends.

The second acting portion is capable of moving the holding portion in a second direction that is opposite to the first direction extending in parallel with the direction in which the primary shaft portion extends.

In the image display unit, the holding portion that holds the image display device is connected to the primary shaft portion to be movable in parallel with the direction in which the primary shaft portion extends. Further, the first and second acting portions are provided, the first acting portion being capable of pressing the holding portion in the first direction in parallel with the direction in which the primary shaft portion extends, the second acting portion being capable of pressing the holding portion in the second direction in parallel with the direction in which the primary shaft portion extends. This makes it possible to stably control the movement of the image display device with a high degree of accuracy.

The holding portion may hold the image display device such that an image display surface of the image display device is arranged parallel to a movement-plane direction that is a specified planar direction including the direction in which the primary shaft portion extends.

The image display unit may further include a secondary shaft portion that extends in a direction that is the same as the direction in which the primary shaft portion extends. In this case, the holding portion may be connected to the secondary shaft portion to be movable in parallel with the direction in which the secondary shaft portion extends.

The secondary shaft portion may be arranged side by side with the primary shaft portion in parallel with the movement-plane direction.

The image display unit may further include a pressing portion that presses the holding portion in parallel with an orthogonal direction that is orthogonal to the movement-plane direction.

The pressing portion may be capable of pressing the holding portion in a direction from a rear side to a front side of the image display surface of the image display device, or in a direction from the front side to the rear side of the image display surface of the image display device.

The pressing portion may include a prevention mechanism that prevents a force from being generated in parallel with a direction that is different from the orthogonal direction according to the movement of the holding portion.

The prevention mechanism may be capable of preventing the force from being generated in parallel with the movement-plane direction according to the movement of the holding portion.

The prevention mechanism may allow the pressing portion to be deformed in parallel with the movement-plane direction according to the movement of the holding portion.

The first acting portion and the second acting portion may be capable of moving the holding portion such that the image display device in a state of being held by the holding portion reciprocates between a first position and a second position that is different from the first position.

The first acting portion may be capable of switching between performing an operation of applying, on the holding portion, a force for moving the holding portion, and canceling the operation of applying, on the holding portion, the force for moving the holding portion. In this case, the second acting portion may be configured such that the operation of applying, on the holding portion, the force for moving the holding portion is maintained.

The first acting portion may apply, on the holding portion, the force for moving the holding portion, such that the image display device moves to the first position. In this case, the second acting portion may apply, on the holding portion, the force for moving the holding portion, such that the image display device moves to the second position when the first acting portion cancels the operation of applying, on the holding portion, the force for moving the holding portion.

The image display device may include a plurality of pixels. In this case, the holding portion may hold the image display device such that a direction of a diagonal of each of the plurality of pixels is parallel to the direction in which the primary shaft portion extends.

The second position may be situated away from the first position in the direction in which the primary shaft portion extends by a distance corresponding to one half of a length of the diagonal of each of the plurality of pixels.

The first acting portion and the second acting portion may be capable of moving the holding portion such that the image display device reciprocates between the first position and the second position in a cycle depending on a frame rate of an image displayed by the image display device.

The first acting portion may include a piezoelectric element.

The second acting portion may include a plate spring.

The pressing portion may include a coil spring.

The image display unit may further include a sleeve that is movably coupled to the primary shaft portion. In this case, the holding portion may be connected to the primary shaft portion through the sleeve.

The holding portion may include a holding surface that holds the image display device, and a connection portion that is provided on a rear side of the holding surface and connected to the primary shaft portion.

A projector according to an embodiment of the present technology includes the image display device, a projection section, the primary shaft portion, the holding portion, the first acting portion, the second acting portion, and a control section.

The projection section includes a plurality of lenses and projects an image generated by the image display device.

The control section is capable of controlling an image display operation performed by the image display device, and is capable of controlling at least one of an operation of moving the holding portion that is performed by the first acting portion, or an operation of moving the holding portion that is performed by the second acting portion.

Further, the first acting portion and the second acting portion are capable of moving the holding portion such that the image display device reciprocates between the first position and the second position in a cycle depending on a frame rate of an image displayed by the image display device.

### Advantageous Effects of Invention

As described above, the present technology makes it possible to stably control the movement of an image display device with a high degree of accuracy. Note that the effect described here is not necessarily limitative, and any of the effects described in the present disclosure may be provided.

### BRIEF DESCRIPTION OF DRAWINGS

FIG. 1 schematically illustrates an example of a configuration of an image display apparatus according to an embodiment of the present technology.

FIG. 2 is a schematic diagram describing an operation of shift of an image display device.

FIG. 3 schematically illustrates some of pixels that are included in the image display device.

FIG. 4 is a set of timing charts each illustrating an example of a control of movement of the image display device and of a control of an image display operation that is performed by the image display device.

FIG. 5 is a front view of an image display unit as viewed from the front.

FIG. 6 is a rear view of the image display unit as viewed from the rear.

FIG. 7 is a perspective view of the image display unit as viewed from the diagonally upper rear.

FIG. 8 is a cross-sectional view taken along the line A-A of FIG. 6.

FIG. 9 is a diagram describing a positional relationship between respective members in the image display unit 30.

FIG. 10 is a diagram describing the positional relationship between the respective members in the image display unit 30.

FIG. 11 is a diagram describing the positional relationship between the respective members in the image display unit 30.

FIG. 12 is a diagram describing the positional relationship between the respective members in the image display unit 30.

FIG. 13 is a perspective view of the image display unit as viewed from the rear.

FIG. 14 is a schematic diagram describing discussions on a pressing portion.

### MODE(S) FOR CARRYING OUT THE INVENTION

Embodiments according to the present technology will now be described below with reference to the drawings.

[General Description of Image Display Apparatus]

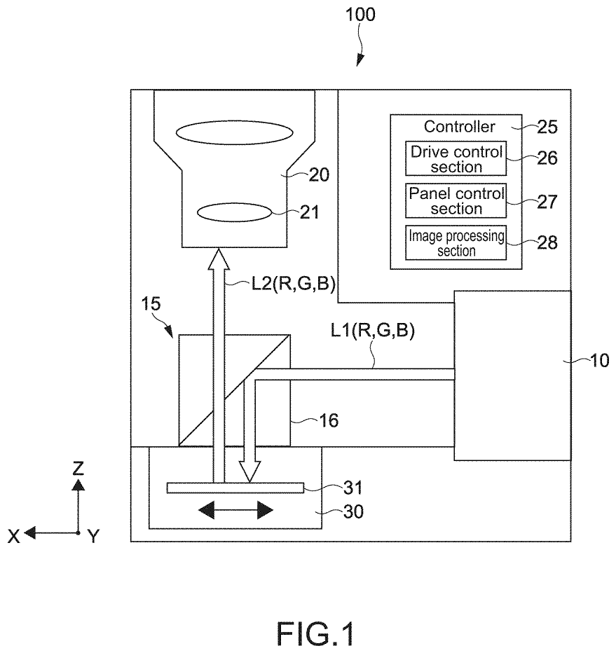

FIG. 1 schematically illustrates an example of a configuration of an image display apparatus according to an embodiment of the present technology. An image display apparatus 100 is used as a projector for, for example, a presentation or a digital cinema. The present technology described below is applicable to any image display apparatus used for other purposes.

FIG. 1 schematically illustrates the image display apparatus 100 as viewed from above. In the following description, a left-right direction, a height direction, and a front-rear direction of the image display apparatus 100 as viewed from the front (as viewed from the upper side to the lower side in the figure) are respectively set to be an X direction, a Y direction, and a Z direction. Of course, such a setting of the direction is not limitative.

The image display apparatus 100 includes a light source section 10, an illumination section 15, a projection section 20, a controller (a control section) 25, and an image display unit 30.

The light source section 10 emits, to the illumination section 15, light L1 used to generate an image. In the present embodiment, red light R, green light G, and blue light B are respectively emitted by the light source section 10 in a time-divided manner.

The configuration of the light source section 10 is not limited, and may be designed discretionarily. For example, a red laser light source, a green laser light source, and a blue laser light source may be respectively arranged to be driven in a time-divided manner. Alternatively, white light emitted by, for example, a white laser light source, a white LED, or a white lamp may be divided into respective pieces of light of red, green, and blue to be emitted. Still alternatively, a phosphor or the like that emits visible light using excitation light may be used to generate the respective pieces of light of red, green, and blue.

The light L1 emitted to generate an image is not limited to the respective pieces of light of red, green, and blue. For example, light of another wavelength band, or light such as white light that is obtained by combining pieces of light of multiple wavelength bands may be emitted. Of course, any optical member such as a reflective mirror or an exit lens may be used to emit the light L1.

The illumination section 15 emits, to an image display device 31 included in the image display unit 30, red light R, green light G, and blue light B that are emitted from the light source section 10. Further, the illumination section 15 emits, to the projection section 20, image light L2 that makes up an image generated by the image display device 31.

As illustrated in FIG. 1, the illumination section 15 includes a prism-type polarization beam splitter (PBS) 15. Light that is s-polarized light with respect to joint surfaces of prisms is reflected off the PBS 16, and light that is p-polarized light with respect to the joint surfaces is transmitted through the PBS 16.

In the present embodiment, alignment with respect to the light L1 (the red light R, the green light G, and the blue light B) emitted from the light source section 10 is performed by a polarization conversion element (not illustrated), such as a polarizing plate, that is included in illumination section 15. The polarization direction of the light L1 is controlled such that the light L1 is s-polarized light with respect to the joint surfaces of the prisms of the PBS 16. The light L1 having entered the PBS 16 is reflected off the joint surfaces and emitted to the image display device 31 arranged in a light path of the light L1.

A p-polarization component of the image light L2 generated by the image display device 31 is transmitted through the joint surfaces of the PBS 16 and emitted to the projection section 20 arranged in a light path of the image light L2. In the present embodiment, image light L2 of red light R, image light L2 of green light G, and image light L2 of blue light B are emitted to the projection section 20 in a time-divided manner.

The configuration of the illumination section 15 is not limited, and may be designed discretionarily. For example, any integrator optical system used to perform adjustment such that the light L1 has a distribution of a uniform brightness may be arranged as the illumination section 15. Moreover, any optical member such as a polarization conversion element such as a polarizing plate and a wavelength plate, and various lenses such as a relay lens and a condenser lens, may be used.

The projection section 20 includes, for example, a plurality of lenses 21, and projects an image generated by the image display unit 30 onto, for example, a screen (not illustrated). In the present embodiment, the projection section 20 projects, in a time-divided manner, pieces of image light L2 of respective colors that are emitted by the illumination section 15. This results in a full-color image being displayed. The specific configuration of the projection section 20 is not limited, and may be designed discretionarily.

The image display unit 30 includes the reflective image display device 31. In the present embodiment, a full HD (2,070,000-pixel) liquid crystal panel with 1,920 pixels in width and 1,080 pixels in height is used as the image display device 31. Of course, the number of pixels, a pixel pitch, and the like of the image display device 31 are not limited, and may be designed discretionarily.

According to an image signal that includes image information, pieces of light L1 of the respective colors of red, green, and blue that are emitted from the illumination section 15 are modulated by the image display device 31 to be reflected off the image display device 31. This results in pieces of image light (modulated light) L2 of the respective colors being emitted to the PBS 16 of the illumination section 15.

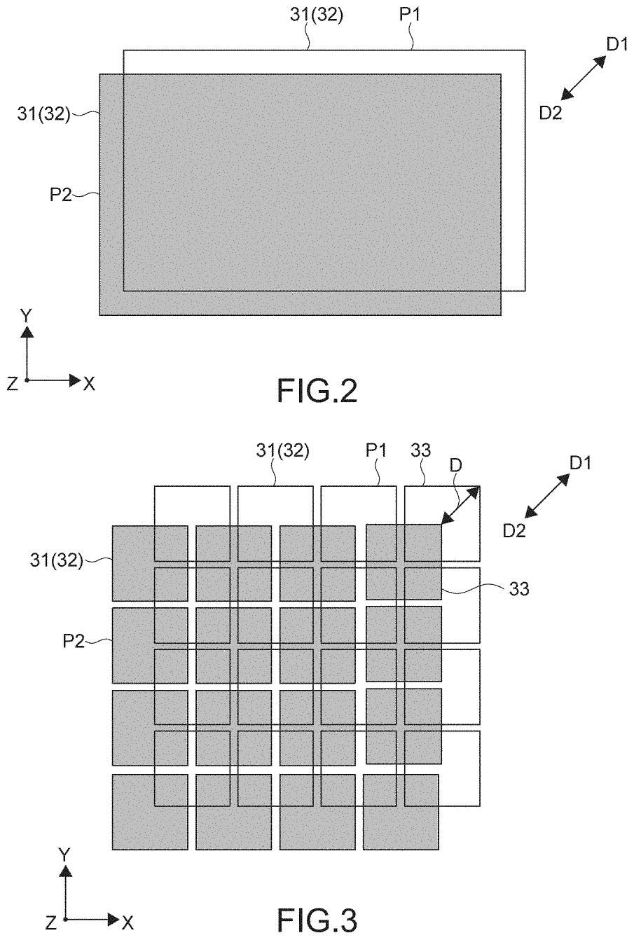

FIGS. 2 and 3 are schematic diagrams describing an operation of shift of the image display device 31. The setting of the X, Y, and Z directions in FIGS. 2 and 3 is similar to the setting in FIG. 1. Thus, FIGS. 2 and 3 schematically illustrate the image display device 31 as viewed from the front of the image display apparatus 100.

In other words, FIGS. 2 and 3 are schematic front views of the image display device 31 as viewed from the front. The side of the image display device 31 from which image light L2 is emitted is referred to as a front side, and the opposite side is referred to as a rear side. Further, the surface of the image display device 31 from which the image light L2 is emitted is referred to as an image display surface 32. Thus, it can also be said that FIGS. 2 and 3 are schematic diagrams of the image display surface 32 of the image display device 31 as viewed from the front side.

In the image display unit 30 according to the present embodiment, it is possible to finely move the image display device 31 at a high speed and to maintain the degree of accuracy in braking of the image display device 31 very high. Note that FIG. 2 schematically illustrates a movement distance (a displacement amount) of the image display device 31 in a very large size in order to describe an operation of shift of the image display device 31 in an easy-to-understand manner.

As illustrated in FIG. 2, in the present embodiment, it is possible to accurately move the image display device 31 (the image display surface 32) at a high speed between a first position P1 and a second position P2 in parallel with a planar direction (a direction of an XY plane) that is orthogonal to a direction in which the image light L2 is emitted, the second position P2 being different from the first position P1. In other words, it is possible to move the image display device 31 (the image display surface 32) such that the image display device 31 (the image display surface 32) accurately reciprocates at a high speed between the first and second positions P1 and P2. The XY-plane direction in which the image display device 31 (the image display surface 32) moves may be hereinafter referred to as a movement-plane direction.

FIG. 3 schematically illustrates some of pixels 33 that are included in the image display device 31. As illustrated in FIG. 3, in the present embodiment, the image display device 31 is moved in parallel with a direction of a diagonal (an arrow D) of each pixel 33. Further, the image display device 31 is moved at a high speed, with one half of a length of the diagonal (a diagonal length) of each pixel 33 being a displacement amount of the image display device 31.

Thus, the first position P1 and the second position P2 are situated away from each other in the direction of the diagonal of the pixel 33 by a distance corresponding to one half of the diagonal length of the pixel 33. In other words, the second position P2 is situated away from the first position P1 in the direction of the diagonal of the pixel 33 by the distance corresponding to one half of the diagonal length of the pixel 33.

As indicated by a diagonally-oriented arrow illustrated in, for example, FIGS. 2 and 3, a direction from the second position P2 to the first position P1 will be hereinafter referred to as a first direction D1. Further, a direction from the first position P1 to the second position P2 will be hereinafter referred to as a second direction D2. The first and second directions D1 and D2 can also be respectively referred to as first and second orientations.

For example, when the diagonal length of the image display device 31 is N inches, the number of pixels of the image display device 31 is “L pixels in width×M pixels in height”, and the aspect ratio of the image display device 31 is “O in width:P in height”, a displacement amount x (one half of the diagonal length of the pixel 33) can be calculated using the following formula.

$$x = N \times 25.4 \times \frac{O}{\sqrt{{O}^{2} + {P}^{2}}} \times \frac{1}{L} \times \frac{\sqrt{2}}{2} \qquad [ Formula 1 ]$$

Note that the calculation using the formula described above corresponds to the following. The diagonal length of the image display device 31 is converted into millimeters from inches to calculate the length of the width of the image display device 31. The calculated length is divided by the number of pixels in width to calculate a pixel size. Then, using the calculated pixel size, one half of the diagonal length of the pixel 33 is calculated.

In the present embodiment, a liquid crystal panel in which the diagonal length is about 0.37 inches and the aspect ratio is “16 in height:9 in width”, is used as the image display device 31. Further, as described above, the number of pixels is 1,920 pixels in width×1,080 pixels in height. Thus, the pixel size is about 4.266 μm, and the displacement amount x (one half of the diagonal length of the pixel 33) is about 3.0 μm.

Of course, the displacement amount is not limited to being calculated using the formula described above, and, for example, the displacement amount may be set as appropriate using, for example, a design value of the image display device 31. The configuration of the image display unit 30, the method for moving the image display device 31, and the like will be described later in detail.

The controller 25 is configured by hardware, such as a CPU and a memory (a RAM and a ROM), that is necessary for a computer. Various processes are performed by the CPU loading, into the RAM, a control program and the like stored in, for example, a memory and executing the control program.

For example, a programmable logic device (PLD) such as a field programmable gate array (FPGA), or other devices such as an application specific integrated circuit (ASIC) may be used as the controller 25. Further, the position to arrange the controller 25 and the like are not limited, and may be designed as appropriate.

In the present embodiment, a drive control section 26, a panel control section 27, and an image processing section 28 are implemented by the CPU of the controller 25 executing a specified program. Dedicated hardware such as an integrated circuit (IC) may be used as appropriate in order to implement these functional blocks.

The drive control section 26 controls an operation of moving the image display device 31 that is performed by the image display unit 30. Specifically, the drive control section 26 controls at least one of an operation of moving a holding portion (a pressing operation in the present embodiment) that is performed by a first acting portion or an operation of moving the holding portion that is performed by a second acting portion, the first and second acting portions being described later. The panel control section 27 controls an image display operation that is performed by the image display device 31. The image processing section 28 performs various image processes on data of a display-target image.

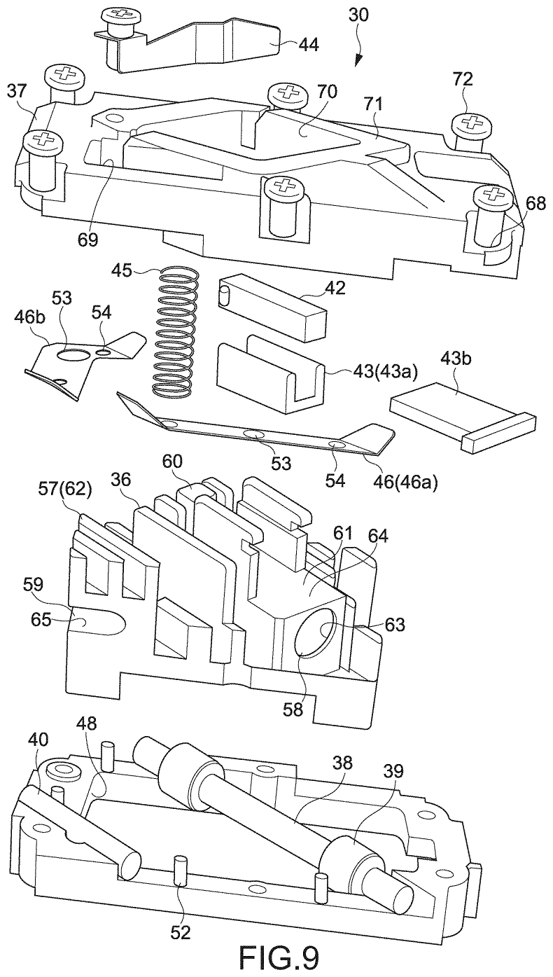

Voltage is supplied to an actuator 42 (refer to, for example, FIG. 9) included in the image display unit 30 according to, for example, a control signal output from the drive control section 26. Further, an image signal voltage is supplied to the image display device 31 according to a control signal output from the panel control section 27. The image processing section 28 performs image processing such as pre-compensation.

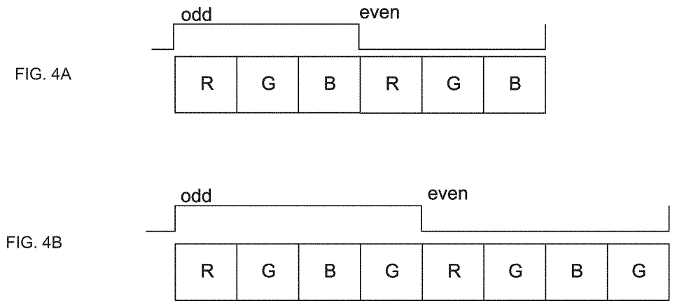

FIG. 4 is a set of timing charts each illustrating an example of a control of movement of the image display device 31 and a control of an image display operation that is performed by the image display device 31.

For example, voltage is supplied to the actuator 42 of the image display unit 30, and the image display device 31 is moved to the first position P1. In synchronization with this timing, an image signal of an odd frame is supplied to the image display device 31. As illustrated in A of FIG. 4, image signals for the respective colors of red, green, and blue are respectively supplied to the image display device 31 due to entrances of pieces of light L1 of the respective colors of red, green, and blue.

At the timing at which a modulation of blue light B of the odd frame is completed, the supply of the voltage to the actuator 42 is stopped, and the image display device 31 is moved to the second position P2. In synchronization with this timing, an image signal of an even frame is supplied to the image display device 31. As illustrated in A of FIG. 4, image signals for the respective colors of red, green, and blue are respectively supplied to the image display device 31 due to entrances of pieces of light L1 of the respective colors of red, green, and blue.

Note that there is no limitation on how many times pieces of light L1 of the respective colors of red, green, and blue are irradiated in a single frame to generate pieces of image light L2 of the respective colors of red, green, and blue how many times. For example, as illustrated in B of FIG. 4, it is possible to irradiate green light G twice in a single frame to generate green image light L2 twice, in order to improve brightness of an image. Moreover, the method for irradiating pieces of light the respective colors of red, green, and blue may be set discretionarily in order to achieve a desired brightness or chromaticity.

As described above, in the present embodiment, when an image of an odd frame and an image of an even frame are respectively projected, the image display device 31 (the image display surface 32) is shifted by half a pixel in a cycle depending on the frame rate of a projected image. For example, when the frame rate is 60 fps, the image display device 31 is moved by about 3 μm in a cycle of 1/60 seconds in the present embodiment.

This makes it possible to enhancing the frequency space and to achieve a high-resolution image display. In the present embodiment, it is possible to display a 4K image with a very high degree of accuracy, using a 0.37-inch full HD liquid crystal panel with 1,920 pixels in width and 1,080 pixels in height.

Achieving a higher image resolution by moving the image display device 31 at a high speed may be hereinafter referred to as sub pixel expansion. The sub pixel expansion can also be considered one of the pixel shift methods described above.

By performing pre-compensation, the image processing section 28 can optimize a high-resolution image displayed due to sub pixel expansion in order to maintain the degree of accuracy in the image high. A specific algorithm for the pre-compensation is not limited, and any algorithm such as super-resolution processing may be performed.

Further, any machine learning algorithm using, for example, a deep neural network (DNN) may be used in order to perform pre-compensation. For example, the use of artificial intelligence (AI) using deep learning makes it possible to improve the accuracy in optimizing an image.

The image display apparatus 100 and the image display unit 30 according to the present embodiment that make it possible to perform sub pixel expansion can also be respectively referred to as a sub pixel expansion apparatus and a sub pixel expansion unit.

[Image Display Unit]

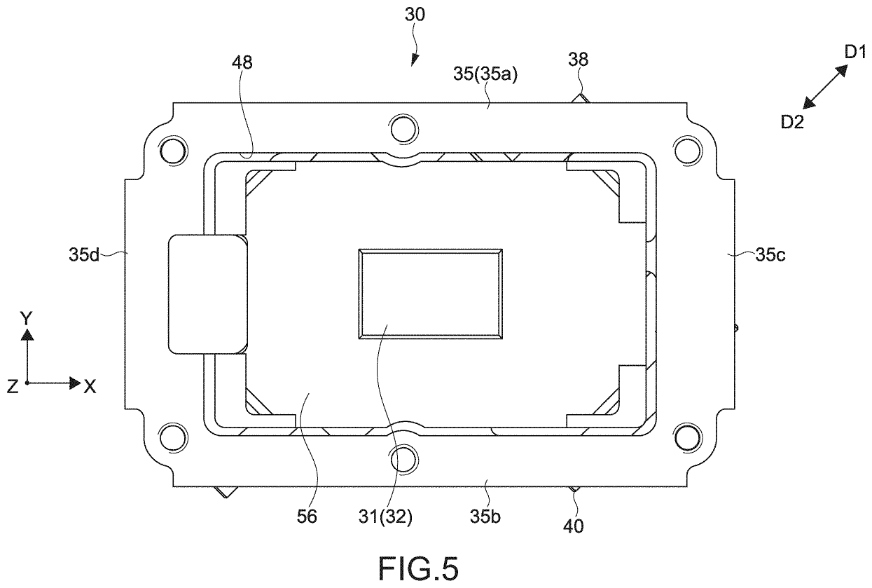

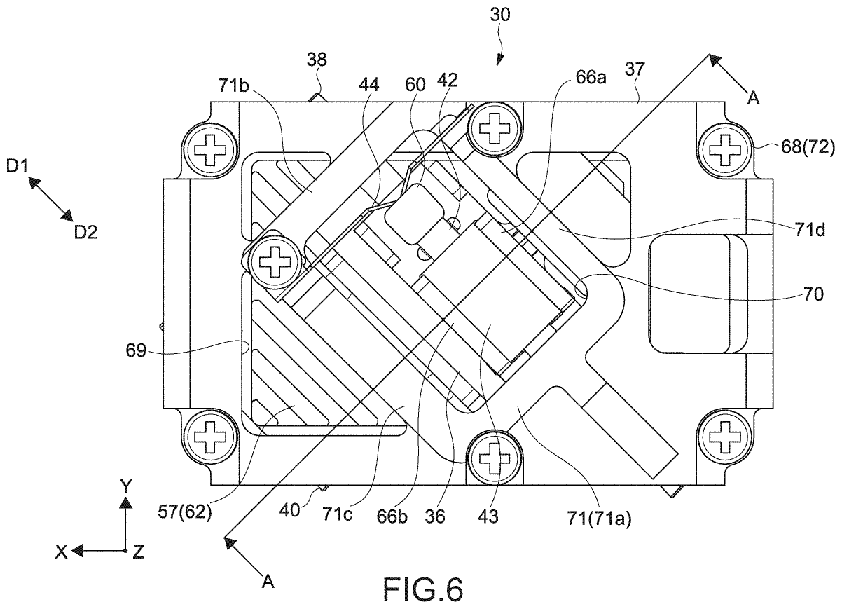

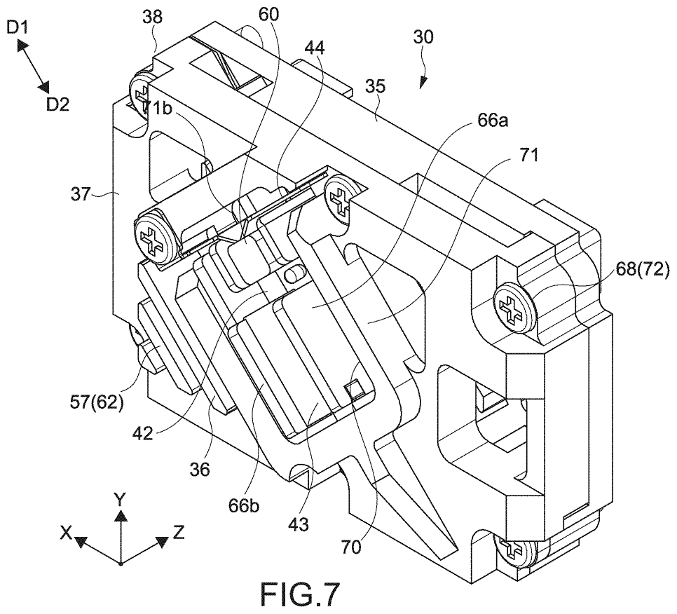

The configuration of the image display unit 30 and the method for moving the image display device are described in detail with reference to FIGS. 5 to 13. FIG. 5 is a front view of the image display unit 30 as viewed from the front. FIG. 6 is a rear view of the image display unit 30 as viewed from the rear. FIG. 7 is a perspective view of the image display unit 30 as viewed from the diagonally upper rear. The setting of the X, Y, and Z directions in FIGS. 5 to 7 is similar to the setting in FIGS. 1 to 3.

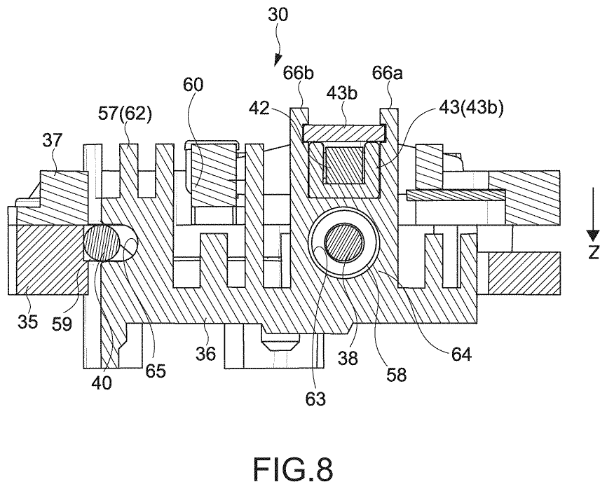

FIG. 8 is a cross-sectional view taken along the line A-A of FIG. 6. The lower side and the upper side in the figure are respectively a front side and a rear side of the image display unit 30.

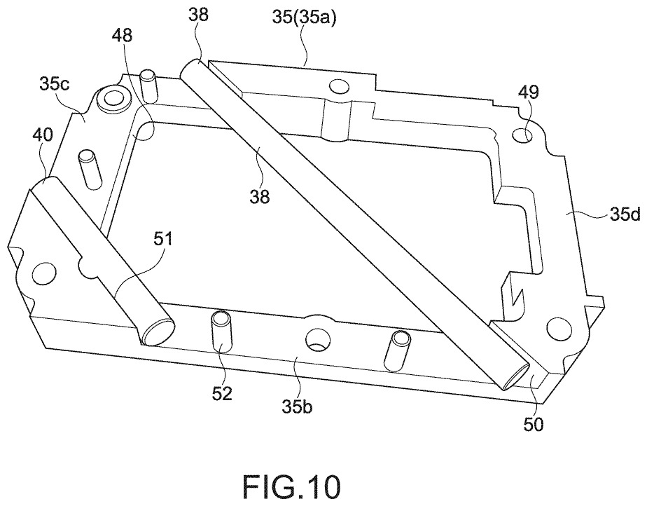

FIGS. 9 to 13 are diagrams describing a positional relationship between respective members in the image display unit 30. In FIG. 9, the lower side and the upper side in the figure are respectively the front side and the rear side of the image display unit 30. FIGS. 10 to 13 each illustrate the image display unit 30 as viewed from the rear side of the image display unit 30.

Regarding reference symbols denoting the respective components, a reference symbol selected as appropriate is illustrated in each of the figures in order to not make the figure complicated. In other words, there are a figure in which a certain component is denoted by a reference symbol, and a figure in which the certain component is not denoted by the reference symbol.

Note that there is a difference in a shape of a partial portion between the image display unit 30 illustrated in FIGS. 5 to 8 and the image display unit 30 illustrated in FIGS. 9 to 13. However, the description is made on the assumption that the image display unit 30 illustrated in FIGS. 5 to 8 and the image display unit 30 illustrated in FIGS. 9 to 13 are the same without distinguishing between them, since they have substantially the same configuration with respect to a primary portion according to the present technology.

As illustrated in, for example, FIG. 9, the image display unit 30 includes the image display device 31, a base frame 35, a panel carrier 36, a cover frame 37, a main shaft 38, a sleeve 39, and a sub shaft 40. The image display unit 30 further includes an actuator 42, an actuator holder 43, a hold-down spring 44, a compression spring (a compression coil spring) 45, and a shaft fixing spring 46 (46a and 46b).

As illustrated in, for example, FIG. 10, the base frame 35 has a substantially rectangular outer shape as viewed in the front-rear direction, and is a frame member that includes a substantially rectangular passing-through opening 48 inside the frame member. From among side portions of the base frame 35 that extend in a longitudinal direction (left-right direction) of the base frame 35, a side portion situated on the upper side is referred to as an upper side portion 35a, and a side portion situated on the lower side is referred to as a lower side portion 35b. Further, from among side portions of the base frame 35 that extend in a lateral direction (up-down direction) of the base frame 35, a side portion situated on the right is referred to as a right side portion 35c, and a side portion situated on the left is referred to as a left side portion 35d.

The upper side portion 35a, the lower side portion 35b, the right side portion 35c, and the left side portion 35d are coupled together to form the base frame 35 that is a frame member. Note that the up-down direction and the left-right direction are directions when the side from which image light L2 is emitted is a front side and the image display unit 30 is viewed from the front side.

As illustrated in FIG. 10, a screw hole 49, a main shaft support portion 50, a sub shaft support portion 51, and a mounting protrusion portion 52 are formed in the base frame 35. Four screw holes 49 are respectively formed in four corners of the base frame 35, that is, coupling portions of the upper side portion 35a, the lower side portion 35b, the right side portion 35c, and the left side portion 35d, and two screw holes 49 are respectively formed in two portions that are respectively situated in substantially the middle of the upper side portion 35a and in substantially the middle of the lower side portion 35b. In other words, six screw holes 49 are formed in the present embodiment.

The main shaft support portion 50 is a portion in which the main shaft 38 is arranged, and a left corner of the lower side portion 35b and a right corner of the upper side portion 35a are each provided with the main shaft support portion 50. In the present embodiment, a level difference is formed as the main shaft support portion 50, and the main shaft 38 is brought into contact with the formed level difference. The configuration for supporting the main shaft 38 is not limited, and a concave or a groove into which the main shaft 38 can be fit, may be formed. Further, a surface of the main shaft support portion 50 that is brought into contact with the main shaft 38 may be formed into a shape of the inner surface of a cylinder in conformity to the curved surface of the main shaft 38.

As illustrated in FIG. 10, in the present embodiment, the main shaft 38 is arranged to obliquely intersect the upper side portion 35a and the lower side portion 35b. The direction in which the main shaft 38 extends is the same as the movement direction of the image display device 31 (the image display surface 32). Thus, the main shaft 38 is arranged on the base frame 35 to extend in a direction that is the same as the direction of the diagonal of the pixel 33 included in the image display device 31.

In the present embodiment, the main shaft 38 corresponds to a primary shaft portion. The movement-plane direction (the XY-plane direction) in which the image display surface 32 of the image display device 31 moves, corresponds to a specified planar direction that includes the direction in which the main shaft 38 extends. Conversely, the main shaft 38 is arranged to extend in a certain direction included in the movement-plane direction. This makes it possible to move the image display surface 32 in parallel with the movement-plane direction.

The sub shaft support portion 51 is a portion in which the sub shaft 40 is arranged, and is provided to a lower right corner at which the lower side portion 35b and the right side portion 35c are coupled to each other. The configuration for supporting the sub shaft 40 is not limited, and may be designed discretionarily.

As illustrated in FIG. 10, in the present embodiment, the sub shaft 40 is arranged to extend in a direction that is the same as the direction in which the main shaft 38 extends. Thus, as in the case of the main shaft 38, the sub shaft 40 is arranged on the base frame 35 in parallel with the movement direction of the image display device 31.

Further, as illustrated in the cross-sectional view of FIG. 8, the sub shaft 40 is arranged side by side with the main shaft 38 at a specified interval in parallel with the movement-plane direction (the XY-plane direction) in which the image display surface 32 of the image display device 31 moves.

This makes it possible to stably arrange the image display surface 32 of the image display device 31 in parallel with the XY-plane direction. Further, when the image display device 31 moves, it is also possible to prevent the image display surface 32 from, for example, rotating, and to accurately stably move the image display surface 32. Note that, in FIG. 8, the left-right direction in the figure corresponds to the movement-plane direction (the XY-plane direction).

In the present embodiment, the sub shaft 40 corresponds to a secondary shaft portion. Material of the main shaft 38 and the sub shaft 40 is not limited, and, for example, metallic material such as stainless or aluminum may be used as appropriate.

Note that the main shaft 38 and the sub shaft 40 are arranged on the base frame 35 after being mounted on the panel carrier 36.

The mounting protrusion portions 52 are portions on which shaft fixing springs 46a and 46b illustrated in FIG. 9 are mounted. As illustrated in FIG. 10, two mounting protrusion portions 52 are formed in the lower side portion 35b to be situated across the screw hole 49, one mounting protrusion portion 52 is formed in the right side portion 35c, and one mounting protrusion portion 52 is formed in an upper right corner at which the right side portion 35c and the upper side portion 35a are coupled to each other. In other words, four mounting protrusion portions 52 are formed in the present embodiment.

As illustrated in FIG. 9, a screw hole 53 and two mounting holes 54 are formed in each of the shaft fixing springs 46a and 46b. The two mounting protrusion portions 52 formed in the lower side portion 35b are respectively inserted into the mounting holes 54 of the shaft fixing spring 46a to fix the shaft fixing spring 46a to the lower side portion 35b. The mounting protrusion portions 52 respectively formed in the right side portion 35c and in the upper right corner are respectively inserted into the mounting holes 54 of the other shaft fixing spring 46b to fix the shaft fixing spring 46b.

A screw 72 used to screw the base frame 35 and the cover frame 37 is mounted to each of the screw holes 53 of the shaft fixing springs 46a and 46b. This results in firmly fixing the shaft fixing springs 46a and 46b between the base frame 35 and the cover frame 37. Note that an adhesive material or the like may be used to fix the shaft fixing springs 46a and 46b.

The shaft fixing springs 46 are plate springs, and each press a corresponding one of ends of the main shaft 38 and a corresponding one of ends of the sub shaft 40. The shaft fixing springs 46 are designed to apply a sufficiently strong pressing force on the main shaft 38 and the sub shaft 40. This makes it possible to sufficiently prevent the main shaft 38 and the sub shaft 40 from being displaced, and to move the image display device 31 with a high degree of accuracy.

As illustrated in FIG. 9, two sleeves 39 are each movably coupled to the main shaft 38 at a position shifted a little inward from a corresponding one of the two ends of the main shaft 38. The shaft fixing springs 46a and 46b each press a portion of the main shaft 38 that is situated closer to a corresponding one of the ends of the main shaft 38 than a corresponding one of the sleeves 39 coupled to the main shaft 38, and fix the main shaft 38.

The specific configuration of the shaft fixing spring 46 and the method for fixing the shaft fixing spring 46 to the base frame 35 are not limited, and may be designed discretionarily. Further, material and the like of the sleeve 39 are not limited, and, for example, metallic material such as stainless or aluminum may be used as appropriate. Furthermore, a lubricant or the like may be applied between the main shaft 38 and the sleeve 39.

The panel carrier 36 includes a holding surface 56, a cooling fin portion 57, a main connection portion 58, a sub connection portion 59, a pressed portion 60, and an actuator arrangement portion 61. As illustrated in FIG. 5, the holding surface 56 is a surface that holds the image display device 31, and is formed on the front side of the panel carrier 36.

The holding surface 56 has a substantially rectangular shape, and holds the image display device 31 in a center portion of the holding surface 56. The image display device 31 is arranged on the holding surface 56 such that a longitudinal direction and a lateral direction of the holding surface 56 are respectively substantially parallel to a longitudinal direction and a lateral direction of the image display device 31.

The holding surface 56 is formed to have a size that fits in the substantially rectangular passing-through opening 48 of the base frame 35. When the image display unit 30 is assembled, the panel carrier 36 is mounted such that the holding surface 56 is situated closer to the front side than a front end of the base frame 35.

Thus, the image display surface 32 of the image display device 31 is also arranged closer to the front side than the base frame 35. The holding surface 56 of the panel carrier 36 is formed parallel to the XY-plane direction. The image display surface 32 of the image display device 31 held by the holding surface 56 is also arranged parallel to the XY-plane direction.

In other words, the panel carrier 36 holds the image display device 31 such that the image display surface 32 is parallel to the movement-plane direction (the XY-plane direction). In other words, the panel carrier 36 is arranged such that the holding surface 56 that holds the image display device 31 is parallel to the movement-plane direction (the XY-plane direction) in which the image display surface 32 is desired to be moved.

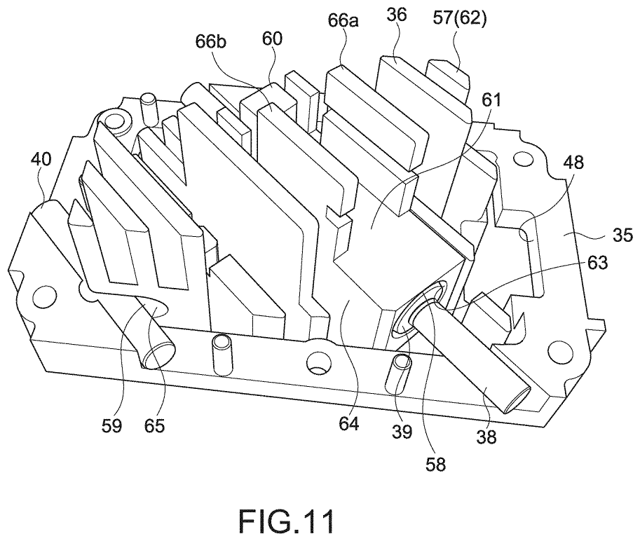

As illustrated in, for example, FIGS. 9 and 11, the cooling fin portion 57, the main connection portion 58, the sub connection portion 59, and the actuator arrangement portion 61 are provided on the rear side of the holding surface 56 of the panel carrier 36.

As illustrated in, for example, FIGS. 11 to 13, the cooling fin portion 57 includes a plurality of pillar portions 62 each extending in a direction toward the rear side of the panel carrier 36. Further, the plurality of pillar portions 62 is formed diagonal to a longitudinal direction of the panel carrier 36 (corresponding to the longitudinal direction of the holding surface 56) such that the plurality of pillar portions 62 extends in a direction that is the same as the direction in which the main shaft 38 extends. The cooling fin portion 57 makes it possible to efficiently cool, for example, the image display device 31 and the actuator 42 by removing the heat generated from the image display device 31 and the actuator 42.

The main connection portion 58 is a portion that is connected to the main shaft 38. In the present embodiment, a passing-through opening 63 is formed that extends in a direction that is the same as the direction in which the main shaft 38 extends, and the main shaft 38 and the panel carrier 36 are connected to each other by the main shaft 38 being inserted into the passing-through opening 63.

As illustrated in, for example, FIGS. 8, 9, and 11, a base portion 64 having an approximate-rectangular-parallelepiped shape is formed in an approximate center on the rear side of the panel carrier 36, with a longitudinal direction of the base portion 64 being the same as the direction in which the main shaft 38 extends. The passing-through opening 63 is formed in the base portion 64. Note that it is also possible to cause the base portion 64 to serve as part of the cooling fin portion 57.

As illustrated in, for example, FIGS. 9 and 11, the inner diameter of the passing-through opening 63 is substantially equal to the outer diameters of the two sleeves 39 movably coupled to the main shaft 38. The two sleeves 39 are inserted into the passing-through opening 63, and the panel carrier 36 and the sleeves 39 are firmly fixed. Thus, in the present embodiment, the panel carrier 36 is connected to the main shaft 38 through the two sleeves 39 to be movable in parallel with a direction in which the main shaft 38 extends.

The sub connection portion 59 is a portion that is connected to the sub shaft 40. In the present embodiment, a groove portion 65 is formed in the lower right corner of the panel carrier 36 in a direction in which the sub shaft 40 extends, that is, a direction that is the same as the direction in which the main shaft 38 extends. The sub shaft 40 and the panel carrier 36 are connected to each other by the sub shaft 40 being inserted into the groove portion 65.

The groove portion 65 is brought into contact with an outer periphery of the sub shaft 40 to be movable in parallel with the direction in which the sub shaft 40 extends. This results in the panel carrier 36 being connected to the sub shaft 40 to be movable in parallel with the direction in which the sub shaft 40 extends.

In the present embodiment, the panel carrier 36 is supported at three points, that is, the two sleeves 39 each coupled to the main shaft 38, and the sub shaft 40. Thus, it is possible to accurately stably support the panel carrier 36. This makes it possible to stably move the image display surface 32 with a high degree of accuracy in parallel with the XY-plane direction that is the movement-plane direction.

The pressed portion 60 is a portion that is pressed by the actuator 42. In the present embodiment, the pressed portion 60 is a pillar portion having an approximate-rectangular-parallelepiped shape that extends in a direction toward the rear side of the panel carrier 36. Note that it is also possible to cause the pressed portion 60 to serve as part of the cooling fin portion 57.

The actuator arrangement portion 61 is a portion in which the actuator 42 is arranged. In the present embodiment, two pillar portions 66a and 66b that face each other are formed on the rear side of the base portion 64. The two pillar portions 66a and 66b and the base portion 64 serve as the actuator arrangement portion 61, and the actuator 42 is arranged in a space between the two pillar portions 66a and 66b situated on the rear side of the base portion 64. Note that it is also possible to cause the two pillar portions 66a and 66b to serve as part of the cooling fin portion 57.

In the present embodiment, a stack-type piezoelectric element that extends in a certain direction is used as the actuator 42. When the actuator 42 is supplied with voltage, the shape of the actuator 42 is changed such that the actuator 42 is longitudinally expanded. When the supply of voltage to the actuator 42 is stopped, the shape of the actuator 42 is changed such that the actuator 42 is longitudinally contracted. The specific configuration of the stack-type piezoelectric element is not limited, and may be designed discretionarily.

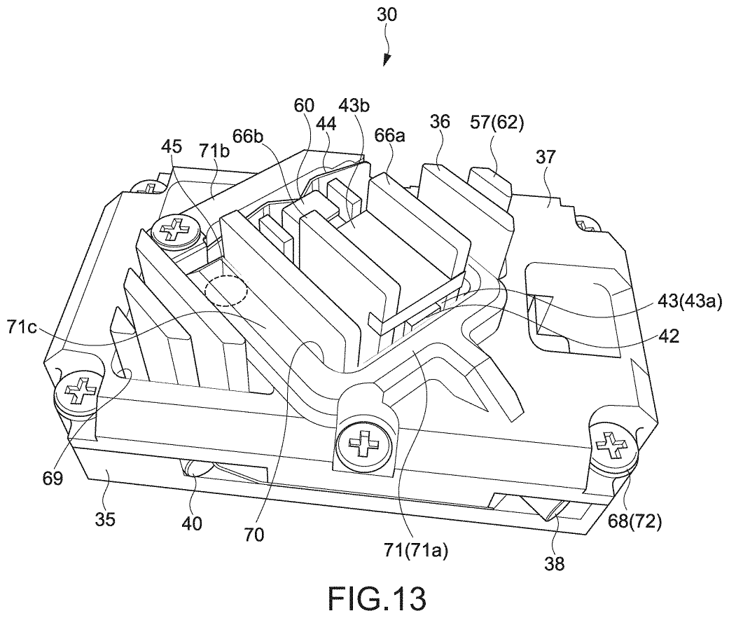

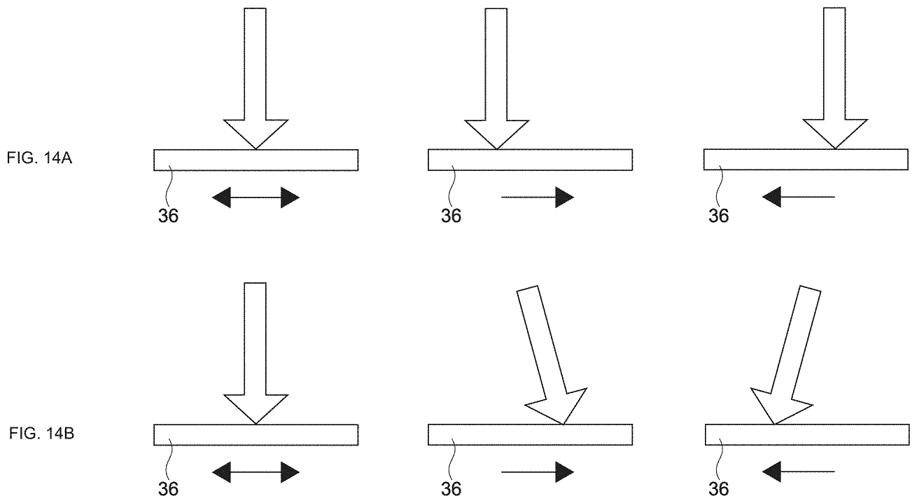

As illustrated in, for example, FIGS. 9 and 13, the actuator 42 is accommodated in the actuator holder 43. The actuator holder 43 includes a holder portion 43a and a cover portion 43b. The holder portion 43a has an approximate-rectangular-parallelepiped shape that extends in a certain direction, and its two ends extending in the longitudinal direction, and one of its four sides are opened. Thus, the holder portion 43a has a substantially U-shaped cross-section, and a groove is longitudinally formed in the holder portion 43a.

The holder portion 43a accommodates the actuator 42 in the longitudinally formed groove. The holder portion 43a is designed to have a length shorter than that of the actuator 42. Thus, the actuator 42 is accommodated in the holder portion 43a such that two ends of the actuator 42 that extend in the longitudinal direction are respectively situated beyond the two ends of the holder portion 43a.

In a state of accommodating therein the actuator 42, the holder portion 43a is arranged in the space between the two pillar portions 66a and 66b that serve as the actuator arrangement portion 61. A groove is formed in each of the two pillar portions 66a and 66b in the longitudinal direction of the holder portion 43a (the actuator 42).

As illustrated in FIG. 13, the actuator 42 is fixed on the rear side of the panel carrier 36 by the cover portion 43b being inserted into these grooves. Note that the end of the actuator 42 that extends in the longitudinal direction is brought into contact with the pressed portion 60, the end being situated on the upper side (on the side of the upper side portion 35a).

When voltage is supplied to the actuator 42, an operation of pressing the panel carrier 36 is performed. In the present embodiment, the actuator 42 is capable of pressing the pressed portion 60 in the first direction D1 extending in parallel with the direction in which the main shaft 38 extends. When the supply of voltage to the actuator 42 is stopped, the pressing force that is a force of the actuator 42 pressing the pressed portion 60 is canceled. This corresponds to an execution of an operation of canceling pressing performed on the panel carrier 36.

In the present embodiment, the actuator 42 corresponds to the first acting portion capable of moving the holding portion in the first direction extending in parallel with the direction in which the primary shaft portion extends. Further, the pressing force of pressing the pressed portion 60 corresponds to a force for moving the holding portion. Furthermore, the operation of pressing the panel carrier 36 corresponds to an operation of applying, on the holding portion, the force for moving the holding portion. Moreover, the cancellation of the pressing force of pressing the pressed portion 60 corresponds to a cancellation of the operation of applying, on the holding portion, the force for moving the holding portion.

The actuator 42 is capable of moving the panel carrier 36 by pressing the panel carrier 36. Thus, the actuator 42 can also be referred to as a first pressing portion. The use of a stack-type piezoelectric element as the first acting portion (the first pressing portion) makes it possible to move the panel carrier 36 using a simple mechanism including fewer components. In other words, it is possible to perform sub pixel expansion with a simple mechanism, and to obtain a smaller apparatus at a lower cost. Note that another pressing mechanism may be provided as the first pressing portion. For example, any pressing mechanism may be used that is capable of pressing the panel carrier 36 using, for example, an elastic force or an electromagnetic force.

The hold-down spring 44 is a plate spring, and is arranged to be brought into contact with the pressed portion 60. As illustrated in, for example, FIGS. 6, 7, and 13, the hold-down spring 44 is arranged to be brought into contact with a certain portion of the pressed portion 60 that is situated opposite to another portion of the pressed portion 60 in the direction in which the main shaft 38 extends, the other portion of the pressed portion 60 being brought into contact with the actuator 42. The hold-down spring 44 is capable of pressing the pressed portion 60 in the second direction D2 extending in parallel with the direction in which the main shaft 38 extends.

As illustrated in, for example, FIGS. 6, 7, and 13, in the present embodiment, an end of the hold-down spring 44 is screwed to be fixed to the cover frame 37. When the cover frame 37 is connected to the base frame 35, a point of application of the hold-down spring 44 that generates a pressing force is brought into contact with the pressed portion 60. The pressed portion 60 enters a state of being constantly pressed by the hold-down spring 44. In other words, the hold-down spring 44 is configured such that an operation of pressing the pressed portion 60 (the panel carrier 36) is maintained.

In the present embodiment, the hold-down spring 44 corresponds to the second acting portion capable of moving the holding portion in the second direction opposite to the first direction extending in parallel with the direction in which the primary shaft portion extends. Further, the pressing force of pressing the pressed portion 60 corresponds to a force for moving the holding portion. Further, the configuration of maintaining the operation of pressing the pressed portion 60 (the panel carrier 36) corresponds to a configuration of maintaining an operation of applying, on the holding portion, the force for moving the holding portion.

The hold-down spring 44 is capable of moving the panel carrier 36 by pressing the panel carrier 36. Thus, the hold-down spring 44 can also be referred to as a second pressing portion. Another type of spring such as a coil spring, or another pressing mechanism including an elastic body other than a spring such as rubber may be used as the second acting portion (the second pressing portion). Note that a space in which the hold-down spring 44 is arranged is formed as appropriate on the rear side of the panel carrier 36.

In the present embodiment, when voltage is supplied to the actuator 42, the pressed portion 60 in a state of being pressed by the hold-down spring 44 is pressed in the first direction D1. This results in moving the image display device 31 (the image display surface 32) to the first position P1. When the supply of voltage to the actuator 42 is stopped and the pressing performed on the pressed portion 60 is canceled, the pressed portion 60 is pressed by the hold-down spring 44 in the second direction D2. This results in moving the image display device 31 (the image display surface 32) to the second position P1.

As described above, the provision of the first and second pressing portions makes it possible to accurately stably move the image display device 31 (the image display surface 32), the first pressing portion being capable of generating a pressing force in the first direction D1, the second pressing portion being capable of generating a pressing force in the second direction D2 that is opposite to the first direction D1.

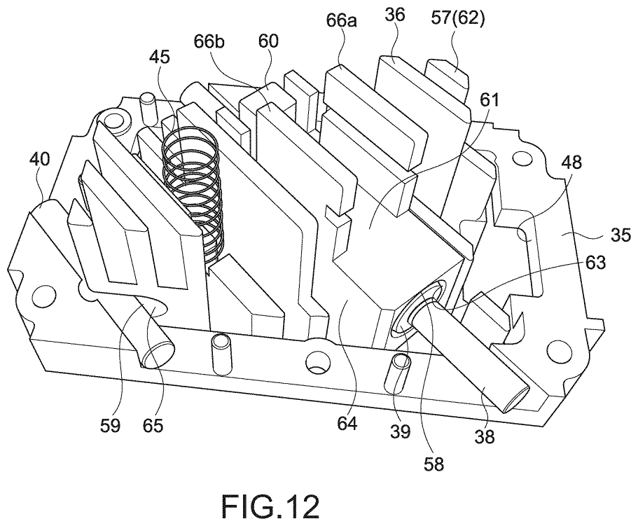

As illustrated in, for example, FIGS. 9 and 12, the compression spring 45 is arranged on the rear side of the panel carrier 36. The compression spring 45 is arranged in the front-rear direction of the image display unit 30 in an approximately middle portion of a space between the main shaft 38 and the sub shaft 40. In other words, the compression spring 45 is arranged in the orthogonal direction orthogonal to the movement-plane direction (the XY-plane direction) including the direction in which the main shaft 38 extends.

The compression spring 45 is arranged in a region situated between the pillar portions 62 formed on the rear side of the panel carrier 36. A front end of the compression spring 45 is brought into contact with a surface on the rear side of the panel carrier 36.

A rear end of the compression spring 45 is brought into contact with the cover frame 37. Thus, when the cover frame 37 is screwed to be connected to the base frame 35, as illustrated in FIG. 13, the compression spring 45 is compressed in the front-rear direction. FIG. 13 schematically illustrates the position of the compression spring 45 with a dashed line.

The compression spring 45 makes it possible to press the panel carrier 36 in parallel with the orthogonal direction orthogonal to the movement-plane direction (the XY-plane direction). The compression spring 45 is capable of pressing the panel carrier 36 in a direction from the rear side to the front side of the image display surface 32 of the image display device 31.

This makes it possible to sufficiently prevent the panel carrier 36 from becoming wobbly, and to stably move the image display surface 32 in parallel with the movement-plane direction (the XY-plane direction) with a high degree of accuracy. In the present embodiment, the compression spring 45 corresponds to a pressing portion. Note that when the first and second pressing portions are respectively provided as the first and second acting portions as in the present embodiment, the pressing portion can also be referred to as a third pressing portion.

Here, the inventors have held numerous discussions on the pressing portion that presses the panel carrier 36 in parallel with the orthogonal direction orthogonal to the movement-plane direction (the XY-plane direction). FIG. 14 is a schematic diagram describing the discussions on the pressing portion.

FIG. 14 schematically illustrates the panel carrier 36. Further, FIG. 14 schematically illustrates the pressing portion and a pressing force generated by the pressing portion using arrows that are each brought into contact with the panel carrier 36.

For the pressing portion that presses the panel carrier 36 in parallel with the orthogonal direction orthogonal to the movement-plane direction (the XY-plane direction), the inventors tried various pressing mechanisms such as a plate spring and a compression spring. Consequently, the inventors have found that, depending on the type of pressing mechanism, a fine and high-speed movement of the panel carrier 36 may be disturbed and this may result in difficulty in stably moving the image display surface 32 with a high degree of accuracy.

For example, it is assumed that only a pressing force in parallel with the orthogonal direction is stably generated when the panel carrier 36 moves, as illustrated in A of FIG. 14. In this case, it is possible to stably move the image display surface 32 with a high degree of accuracy without disturbing a fine and high-speed movement of the panel carrier 36. Note that, even if a portion pressed by the pressing portion is displaced, such a displacement will have little impact since it will be a fine displacement on the order of microns.

It is assumed that the direction of a pressing force generated by the pressing portion is changed when the panel carrier 36 moves, as illustrated in B of FIG. 14. In other words, it is assumed that a force is generated in parallel with a direction different from the orthogonal direction. In this case, it is also possible to press the panel carrier 36 in parallel with the orthogonal direction since there is almost no change in a force applied in the orthogonal direction.

However, there is a good possibility that a fine and high-speed movement of the panel carrier 36 will be disturbed due to a force generated in parallel with a direction different from the orthogonal direction, and, in particular, due to a force generated in parallel with the movement-plane direction (the XY-plane direction).

From such discussions, the inventors have found that it is important to prevent a force from being generated in parallel with a direction different from the orthogonal direction orthogonal to the movement-plane direction (the XY-plane direction), and, in particular, in a direction extending in parallel with the movement-plane direction (the XY-plane direction), according to the movement of the panel carrier 36 in parallel with the direction in which the main shaft 38 extends.

A mechanism for preventing a force from being generated in parallel with a direction different from the orthogonal direction orthogonal to the movement-plane direction (the XY-plane direction) according to the movement of the panel carrier 36, is hereinafter referred to as a prevention mechanism.

A configuration of allowing the pressing portion to be deformed in parallel with the movement-plane direction (the XY-plane direction) according to the movement of the panel carrier 36 is an example of a configuration for implementing the prevention mechanism. The allowance of such deformation makes it possible to prevent the change in a direction of a pressing force illustrated in B of FIG. 14, and to make a state of generating a pressing force closer to the state illustrated in A of FIG. 14.

The compression spring 45 used as the pressing portion in the present embodiment experiences a fine deformation according to the movement of the panel carrier 36. In other words, the compression spring 45 has a configuration in which the compression spring 45 is allowed to be deformed in parallel with the movement-plane direction (the XY-plane direction) according to the movement of the panel carrier 36. In other words, the compression spring 45 includes the prevention mechanism according to the present technology.

Various coil springs can be used as the pressing mechanism including the prevention mechanism. Of course, a plate spring, or another pressing mechanism including an elastic body such as rubber can be used as the pressing mechanism including the prevention mechanism if it is possible to prevent a force from being generated in parallel with a direction different from the orthogonal direction orthogonal to the movement-plane direction (the XY-plane direction). When it is possible to adopt, for example, a plate spring instead of a coil spring, it is possible to make the size in the orthogonal direction smaller, and thus to obtain a smaller apparatus. Further, a method for implementing the prevention mechanism is not limited, and any method may be used.

As illustrated in FIGS. 6, 7, 9, and 13, the cover frame 37 includes seven screw holes 68, a passing-through opening 69 for the cooling fin portion 57, a central passing-through opening 70, and a frame portion 71. From among the seven screw holes 68, the six screw holes 68 formed in the periphery of the cover frame 37 are respectively formed at positions respectively corresponding to the six screw holes 49 formed in the base frame 35. The base frame 35 and the cover frame 37 are connected to be firmly fixed to each other by the screw 72 being mounted to each of the six screw holes 68. The remaining screw hole 68 is used to mount the hold-down spring 44.

The cooling fin portion 57 (the pillar portions 62) provided to the panel carrier 36 is inserted into the passing-through opening 69 for the cooling fin portion 57. For example, the actuator arrangement portion 61 (the base portion 64, and the pillar portions 66a and 66b) and the pressed portion 60 that are provided to the panel carrier 36 are inserted into the central passing-through opening 70. The central passing-through opening 70 has a substantially rectangular shape having sides in the direction in which the main shaft 38 extends, and sides in a direction orthogonal to the direction in which the main shaft 38 extends.

As illustrated in FIGS. 6 and 13, the frame portion 71 is provided around the periphery of the central passing-through opening 70, and includes first to fourth side portions 71a to 71d, the first side portion 71a and the second side portion 71b facing each other in the direction in which the main shaft 38 extends, the third side portion 71c and the fourth side portion 71d extending in the direction in which the main shaft 38 extends. The first, third, and fourth side portions 71a, 71c, and 71d are coupled together, and the second side portion 71b is arranged away from an end of the third side portion 71c and an end of the fourth side portion 71d.

The screw hole 68 (the seventh screw hole) is formed in an end of the second side portion 71b, and the end of the hold-down spring 44 is coupled to the formed screw hole 68. The hold-down spring 44 is arranged between the second side portion 71b and the end of the third side portion 71c and between the second side portion 71b and the end of the fourth side portion 71d. Further, the hold-down spring 44 is supported by the second side portion 71b, and generates a pressing force applied on the pressed portion 60.

The end of the actuator 42 that is opposite to the end of the actuator 42 that is brought into contact with the pressed portion 60, is brought into contact with the first side portion 71a formed in the cover frame 37. When the base frame 35 and the cover frame 37 are connected to each other, the position of the first side portion 71a is fixed. Thus, the actuator 42 is expanded and contracted, with the portion brought into contact with the first side portion 71a being used as a point of reference. This makes it possible to press the pressed portion 60 in the first direction D1 when voltage is supplied to the actuator 42.

Material of the base frame 35, the panel carrier 36, and the cover frame 37 is not limited, and a highly thermally conductive metallic material such as aluminum or copper may be used as appropriate. Of course, another material may be used.

As described above, in the image display apparatus 100 according to the present embodiment, the panel carrier 36 that holds the image display device 31 is connected to the main shaft 38 to be movable in parallel with the direction in which the main shaft 38 extends. Further, the actuator 42 and the hold-down spring 44 are provided, the actuator 42 being capable of pressing the panel carrier 36 in the first direction D1 in parallel with the direction in which the main shaft 38 extends, the hold-down spring 44 being capable of pressing the panel carrier 36 in the second direction D2 in parallel with the direction in which the main shaft 38 extends. This makes it possible to stably control the movement of the image display device 31 with a high degree of accuracy. Further, it is possible to sufficiently prevent a reduction in accuracy upon assembly or upon continuous use.

The resolution of a commonly-used display device such as a TV, a PC, and a mobile apparatus has become higher. For example, when an image is projected onto, for example, a table using, for example, an ultra-short focus projector, the image is viewed at a closer range, and thus there is a need to project a high-resolution image. The demand for a high-resolution display device will be increased in the future.

On the other hand, there is much difficulty in making a pixel finer. For example, there is a need to reduce the pixel pitch up to about 2 μm in order to display a 4K image using a 0.37-inch panel. Thus, it is difficult to easily achieve such a display.

In the present embodiment, sub pixel expansion is performed by directly linearly moving the image display device 31 with a very high degree of accuracy. This makes it possible to display a 4K image with a very high degree of accuracy using a full HD liquid crystal panel with 1,920 pixels in width and 1,080 pixels in height. This also makes it possible to reduce the size and the cost of an optical system.

Further, it is also possible to easily provide a function of sub pixel extension by mounting the image display unit 30 according to the present technology for the light source section 10, the illumination section 15, and the projection section 20 to apply the configuration illustrated in FIG. 1. In other words, it is possible to easily perform sub pixel expansion by replacing, in an existing configuration, a unit that holds an image display device with the image display unit 30 according to the present technology.

In the present embodiment, the use of the main shaft 38 and the sleeve 39 defines the direction of a sliding axis of the panel carrier 36. Then, when the movement route from the second position P2 to the first position P1 is referred to as a going route, and the movement route from the first position P1 to the second position P2 is referred to as a return route, a movement in the first direction D1 along the going route is performed by the actuator 42. Then, a movement in the second direction D2 along the return route is performed by the hold-down spring 44. This results in being able to stably move the image display device 31 between the first and second positions P1 and P2 with a very high degree of accuracy.

For example, it is assumed that the panel carrier 36 and the actuator 42 are coupled to each other to perform a movement along the return route due to contraction of the actuator 42. In this case, tensile stress is generated due to the contraction of the actuator 42, and this may result in reducing a performance of the actuator 42 or in breaking down the actuator 42.

In the present embodiment, the hold-down spring 44 presses the panel carrier 36 in second direction D2. This results in stably performing a movement along the return route with a high degree of accuracy, and it is possible to sufficiently prevent a problem such as the breakdown of the actuator 42 described above. Further, the hold-down spring 44 makes it possible to sufficiently bring the panel carrier 36 into contact with the actuator 42. Consequently, it is also possible to improve the accuracy in a movement along the going route that is performed due to a pressing force of the actuator 42.

Further, the compression spring 45 presses the panel carrier 36 in parallel with the orthogonal direction orthogonal to the movement-plane direction (the XY-plane direction) in which the image display surface 32 of the image display device 31 is arranged. This makes it possible to, for example, prevent the position of the panel carrier 36 in the orthogonal direction from being changed.

For example, even when it is difficult to avoid occurrence of a clearance due to manufacturing reasons, it is possible to control the clearance by pressing the panel carrier 36. Consequently, even when an external force or the like is generated, it is possible to sufficiently prevent the panel carrier 36 from becoming wobbly, and to stably move the image display surface 32 in parallel with the movement-plane direction (the XY-plane direction) with a high degree of accuracy.

Further, the panel carrier 36 is connected to the main shaft 38 and the sub shaft 40 on the rear side (the side of the back surface) of the image display device 31. Furthermore, the actuator 42, the hold-down spring 44, and the compression spring 45 are arranged on the rear side of the panel carrier 36. Thus, a configuration for moving the image display surface 32 along a specified control plane (a plane parallel to the movement-plane direction) is provided on the rear side of the image display device 31. This makes it possible to make the image display unit 30 smaller, and thus to make the image display apparatus 100 smaller.

Further, since there is no need to provide a mechanism for moving the image display surface 32 in a light path of image light, a degree of freedom of design of the illumination section 15 and the projection section 20 is not restricted. Thus, it is possible to make the illumination section 15 and the projection section 20 smaller. Further, the brightness of the image light is not limited, and this offers an advantage in achieving a higher brightness.

Furthermore, since the image display device 31 is directly moved, it is possible to provide a simpler mechanism at a lower cost and to achieve a higher brightness, compared to when a pixel shift is performed by splitting and moving a light path.

Moreover, with respect to the accuracy in scraping of a member, it is possible to process the external surface, the internal surface, and the like of a cylindrical component with a very high degree of accuracy to manufacture the component. Also considering this point, in the present embodiment, the main shaft 38, the sleeve 39, the sub shaft 40, the main connection portion 58, and the sub connection portion 59 are each formed to have a cylindrical shape (including the case in which a portion of the component has a cylindrical shape). This makes it possible to manufacture each member with a very high degree of accuracy in processing. This results in being able to stably move the image display surface 32 along a specified control plane with a very high degree of accuracy.

The present technology is not limited to being applied to a projector, and is applicable to various apparatuses that are capable of displaying an image. For example, a TV, a laptop PC, a tablet terminal, a smartphone, a digitizer, a personal digital assistant (PDA), a portable AV player, a digital still camera, a camcorder, a game device, an electronic book terminal, an automatic teller machine (ATM), a ticket machine at a station, a car navigation system, and the like may be configured as image display apparatuses according to the present technology.

### Other Embodiments

The present technology is not limited to the embodiments described above, and may achieve other various embodiments.

In the description above, sub pixel expansion is performed by displacing the image display device (the image display surface) by half a pixel in parallel with a direction of a diagonal of the pixel. The direction of moving the image display device (the image display surface) and the movement amount (the displacement amount) are not limited, and may be set discretionarily. For example, the image display device (the image display surface) may be moved in the horizontal direction or vertical direction in which pixels are arranged. Further, a distance corresponding to a third of a pixel or a distance corresponding to a quarter of a pixel may be set as the displacement amount.

In the description above, the first and second pressing portions that press the panel carrier are provided as the first and second acting portions that move the panel carrier. The configuration of the first and second acting portions is not limited to this, and a configuration that moves the panel carrier in directions in which the first and second acting portions are contracted, may be adopted as the configuration of the first and second acting portions.

For example, it is assumed that a state in which voltage is being supplied to a piezoelectric element used as the first acting portion (a state in which the piezoelectric element is expanded) is referred to as an initial state. The supply of voltage is canceled, the piezoelectric element is deformed to be contracted, and a space is formed. The panel carrier is moved to the formed space using a spring used as the second acting portion. For returning to the initial state, voltage is supplied to the piezoelectric element, and the piezoelectric element is deformed to be expanded. Such an operation also makes it possible to stably move the image display device between the first and second positions with a high degree of accuracy.

In this configuration, the panel carrier is moved by the first acting portion being contracted and by the second acting portion being expanded (pressing). Further, a movement of the panel carrier is performed by the second acting portion being contracted and by the first acting portion being expanded (pressing). In other words, the panel carrier is moved by the first and second acting portions being alternately expanded and contracted. Thus, this configuration can also be considered a configuration in which first and second expansion-and-contraction portions that can be expanded and contracted are adopted as the first and second acting portions. Of course, the first and second expansion-and-contraction portions also serve as the first and second pressing portions since the panel carrier is pressed by the first and second expansion-and-contraction portions being expanded.

A configuration in which the panel carrier is pulled to be moved, may be adopted as the configuration of the first and second acting portions. A configuration in which tension in a pulling direction is generated can also be considered a configuration of first and second tension portions. Any configuration such as a configuration using an elastic body such as rubber, or a piezoelectric element may be adopted as a configuration of the tension portion. Moreover, any method may be used as a method for moving the panel carrier using the first and second acting portions.

Further, the first and second acting portions are not limited to being separately provided as mechanism sections that are different from each other, and the first and second acting portions may be implemented by a single mechanism. For example, a single reciprocation mechanism may be provided that reciprocates the panel carrier in two directions opposite to each other in parallel with the direction in which the main shaft extends, using a magnetic force (attraction/repulsion) generated using, for example, an electromagnet. The reciprocation mechanism serves as the first acting portion when the panel carrier is moved in one direction, and serves as the second acting portion when the panel carrier is moved in the other direction. The configuration of the reciprocation mechanism is not limited, and may be designed discretionarily. For example, any of the above-described configurations of the “pressing portion”, the “expansion-and-contraction portion”, and the “tension portion” may be adopted.

In the description above, the panel carrier is pressed by the pressing portion in the direction from the rear side to the front side of the image display surface 32 of the image display device 31. The panel carrier 36 is limited to being pressing in this way, and may be pressed by the pressing portion in a direction from the front side to the rear side of the image display surface, in order to prevent the panel carrier from becoming wobbly in a direction orthogonal to the movement-plane direction. For example, the pressing portion is provided on the side of the holding surface that holds the image display device, and the panel carrier is pressed in the direction from the front side to the rear side toward, for example, a support member that supports the rear side of the panel carrier. Such a configuration also makes it possible to provide a similar effect.

In the description above, the main shaft and the sub shaft are arranged side by side in parallel with the movement-plane direction. The arrangement of the main shaft and the sub shaft is not limited to this, and the main shaft and the sub shaft may be arranged at different levels (heights) in the direction orthogonal to the movement-plane direction. In such a case, it is also possible to hold the image display surface parallel to the movement-plane direction by setting the heights of the main connection portion and the sub connection portion of the panel carrier as appropriate.

The present technology is also applicable to a transmissive image display device such as a transmissive liquid crystal panel. Further, the present technology is also applicable to any other image display devices such as a digital micromirror device (DMD) and an organic electro-luminescence (EL) panel.

In the present disclosure, “parallel”, “orthogonal”, “direction that is the same as”, “direction extending in parallel with, and the like include “substantially parallel”, “substantially orthogonal”, “ direction that is substantially the same as”, “direction extending substantially in parallel with”, and the like in concept. For example, states within respective specified ranges (for example, ranges of +/−10%) are also included, where “completely parallel”, “completely orthogonal”, “direction that is exactly the same as”, “direction extending completely in parallel with”, and the like are respectively used as references for the specified ranges.

The respective configurations of the image display apparatus, the light source section, the illumination section, the projection section, the image display unit, the controller (the control section), and the like, as well as a control flow performed by the controller described with reference to the respective figures are merely embodiments, and may be modified discretionarily without departing from the spirit of the present technology. In other words, for example, any other configurations or algorithms for practicing the present technology may be adopted.

For example, a configuration without providing the pressing portion may be adopted. Further, the primary shaft portion may include a plurality of shafts. Furthermore, the secondary shaft portion may include a plurality of shafts.

At least two of the features of the present technology described above can also be combined. In other words, various features described in the respective embodiments may be combined discretionarily regardless of the embodiments. Further, the various effects described above are not limitative but are merely illustrative, and other effects may be provided.

Note that the present technology may also take the following configurations.
(1) An image display unit including:

an image display device;

a primary shaft portion that extends in a direction;

a holding portion that holds the image display device, and is connected to the primary shaft portion to be movable in parallel with the direction in which the primary shaft portion extends;

a first acting portion that is capable of moving the holding portion in a first direction extending in parallel with the direction in which the primary shaft portion extends; and

a second acting portion that is capable of moving the holding portion in a second direction that is opposite to the first direction extending in parallel with the direction in which the primary shaft portion extends.
(2) The image display unit according to (1), in which

the holding portion holds the image display device such that an image display surface of the image display device is arranged parallel to a movement-plane direction that is a specified planar direction including the direction in which the primary shaft portion extends.
(3) The image display unit according to (1) or (2), further including a secondary shaft portion that extends in a direction that is the same as the direction in which the primary shaft portion extends, in which

the holding portion is connected to the secondary shaft portion to be movable in parallel with the direction in which the secondary shaft portion extends.
(4) The image display unit according to (3), in which

the holding portion holds the image display device such that an image display surface of the image display device is arranged parallel to a movement-plane direction that is a specified planar direction including the direction in which the primary shaft portion extends, and

the secondary shaft portion is arranged side by side with the primary shaft portion in parallel with the movement-plane direction.
(5) The image display unit according to any one of (1) to (4), in which

the holding portion holds the image display device such that an image display surface of the image display device is arranged parallel to a movement-plane direction that is a specified planar direction including the direction in which the primary shaft portion extends, and

the image display unit further includes a pressing portion that presses the holding portion in parallel with an orthogonal direction that is orthogonal to the movement-plane direction.
(6) The image display unit according to (5), in which

the pressing portion is capable of pressing the holding portion in a direction from a rear side to a front side of the image display surface of the image display device, or in a direction from the front side to the rear side of the image display surface of the image display device.
(7) The image display unit according to (5) or (6), in which

the pressing portion includes a prevention mechanism that prevents a force from being generated in parallel with a direction that is different from the orthogonal direction according to the movement of the holding portion.
(8) The image display unit according to (7), in which

the prevention mechanism is capable of preventing the force from being generated in parallel with the movement-plane direction according to the movement of the holding portion.
(9) The image display unit according to (7) or (8), in which

the prevention mechanism allows the pressing portion to be deformed in parallel with the movement-plane direction according to the movement of the holding portion.
(10) The image display unit according to any one of (1) to (9), in which

the first acting portion and the second acting portion are capable of pressing the holding portion such that the image display device in a state of being held by the holding portion is movable between a first position and a second position that is different from the first position.
(11) The image display unit according to (10), in which

the first acting portion is capable of switching between performing an operation of applying, on the holding portion, a force for moving the holding portion, and canceling the operation of applying, on the holding portion, the force for moving the holding portion, and

the second acting portion is configured such that the operation of applying, on the holding portion, the force for moving the holding portion is maintained.
(12) The image display unit according to (11), in which

the first acting portion applies, on the holding portion, the force for moving the holding portion, such that the image display device moves to the first position, and

the second acting portion applies, on the holding portion, the force for moving the holding portion, such that the image display device moves to the second position when the first acting portion cancels the operation of applying, on the holding portion, the force for moving the holding portion.
(13) The image display unit according to any one of (1) to (12), in which

the image display device includes a plurality of pixels, and

the holding portion holds the image display device such that a direction of a diagonal of each of the plurality of pixels is parallel to the direction in which the primary shaft portion extends.
(14) The image display unit according to (13), in which

the first acting portion and the second acting portion are capable of moving the holding portion such that the image display device in state of being held by the holding portion reciprocates between a first position and a second position that is different from the first position, and

the second position is situated away from the first position in the direction in which the primary shaft portion extends by a distance corresponding to one half of a length of the diagonal of each of the plurality of pixels.
(15) The image display unit according to (14), in which

the first acting portion and the second acting portion are capable of moving the holding portion such that the image display device reciprocates between the first position and the second position in a cycle depending on a frame rate of an image displayed by the image display device.
(16) The image display unit according to any one of (1) to (15), in which

the first acting portion includes a piezoelectric element.
(17) The image display unit according to any one of (1) to (16), in which

the second acting portion includes a plate spring.
(18) The image display unit according to any one of (5) to (9), in which

the pressing portion includes a coil spring.
(19) The image display unit according to any one of (1) to (18), further including a sleeve that is movably coupled to the primary shaft portion, in which

the holding portion is connected to the primary shaft portion through the sleeve.
(20) A projector including:

an image display device;

a projection section that includes a plurality of lenses and projects an image generated by the image display device;

a primary shaft portion that extends in a direction;

a holding portion that holds the image display device, and is connected to the primary shaft portion to be movable in parallel with the direction in which the primary shaft portion extends;

a first acting portion that is capable of moving the holding portion in a first direction extending in parallel with the direction in which the primary shaft portion extends;

a second acting portion that is capable of moving the holding portion in a second direction that is opposite to the first direction extending in parallel with the direction in which the primary shaft portion extends; and

a control section that is capable of controlling an image display operation performed by the image display device, and is capable of controlling at least one of an operation of moving the holding portion that is performed by the first acting portion, or an operation of moving the holding portion that is performed by the second acting portion, in which

the first acting portion and the second acting portion are capable of moving the holding portion such that the image display device reciprocates between the first position and the second position in a cycle depending on a frame rate of an image displayed by the image display device.
(21) The image display unit according to any one of (1) to (18), in which

the holding portion includes a holding surface that holds the image display device, and a connection portion that is provided on a rear side of the holding surface and connected to the primary shaft portion.

### REFERENCE SIGNS LIST

D1 first direction
D2 second direction
P1 first position
P2 second position
10 light source section
15 illumination section
20 projection section
25 controller
26 drive control section
27 panel control section
28 image processing section
30 image display unit
31 image display device
32 image display surface
33 pixel
35 base frame
36 panel carrier
37 cover frame
38 main shaft
39 sleeve
40 sub shaft
42 actuator
44 hold-down spring
45 compression spring
56 holding surface
58 main connection portion
59 sub connection portion
60 pressed portion
100 image display apparatus

1. An image display unit comprising:
an image display device;
a primary shaft portion that extends in a direction;
a holding portion that holds the image display device, and is connected to the primary shaft portion to be movable in parallel with the direction in which the primary shaft portion extends;
a first acting portion that is capable of moving the holding portion in a first direction extending in parallel with the direction in which the primary shaft portion extends; and
a second acting portion that is capable of moving the holding portion in a second direction that is opposite to the first direction extending in parallel with the direction in which the primary shaft portion extends.

2. The image display unit according to claim 1, wherein the holding portion holds the image display device such that an image display surface of the image display device is arranged parallel to a movement-plane direction that is a specified planar direction including the direction in which the primary shaft portion extends.

3. The image display unit according to claim 1, further comprising a secondary shaft portion that extends in a direction that is the same as the direction in which the primary shaft portion extends, wherein
the holding portion is connected to the secondary shaft portion to be movable in parallel with the direction in which the secondary shaft portion extends.

4. The image display unit according to claim 3, wherein
the holding portion holds the image display device such that an image display surface of the image display device is arranged parallel to a movement-plane direction that is a specified planar direction including the direction in which the primary shaft portion extends, and
the secondary shaft portion is arranged side by side with the primary shaft portion in parallel with the movement-plane direction.

5. The image display unit according to claim 1, wherein
the holding portion holds the image display device such that an image display surface of the image display device is arranged parallel to a movement-plane direction that is a specified planar direction including the direction in which the primary shaft portion extends, and
the image display unit further comprises a pressing portion that presses the holding portion in parallel with an orthogonal direction that is orthogonal to the movement-plane direction.

6. The image display unit according to claim 5, wherein
the pressing portion is capable of pressing the holding portion in a direction from a rear side to a front side of the image display surface of the image display device, or in a direction from the front side to the rear side of the image display surface of the image display device.

7. The image display unit according to claim 5, wherein
the pressing portion includes a prevention mechanism that prevents a force from being generated in parallel with a direction that is different from the orthogonal direction according to the movement of the holding portion.

8. The image display unit according to claim 7, wherein
the prevention mechanism is capable of preventing the force from being generated in parallel with the movement-plane direction according to the movement of the holding portion.

9. The image display unit according to claim 7, wherein
the prevention mechanism allows the pressing portion to be deformed in parallel with the movement-plane direction according to the movement of the holding portion.

10. The image display unit according to claim 1, wherein
the first acting portion and the second acting portion are capable of moving the holding portion such that the image display device in a state of being held by the holding portion reciprocates between a first position and a second position that is different from the first position.

11. The image display unit according to claim 10, wherein
the first acting portion is capable of switching between performing an operation of applying, on the holding portion, a force for moving the holding portion, and canceling the operation of applying, on the holding portion, the force for moving the holding portion, and
the second acting portion is configured such that the operation of applying, on the holding portion, the force for moving the holding portion is maintained.

12. The image display unit according to claim 11, wherein
the first acting portion applies, on the holding portion, the force for moving the holding portion, such that the image display device moves to the first position, and
the second acting portion applies, on the holding portion, the force for moving the holding portion, such that the image display device moves to the second position when the first acting portion cancels the operation of applying, on the holding portion, the force for moving the holding portion.

13. The image display unit according to claim 1, wherein
the image display device includes a plurality of pixels, and
the holding portion holds the image display device such that a direction of a diagonal of each of the plurality of pixels is parallel to the direction in which the primary shaft portion extends.

14. The image display unit according to claim 13, wherein
the first acting portion and the second acting portion are capable of moving the holding portion such that the image display device in state of being held by the holding portion reciprocates between a first position and a second position that is different from the first position, and
the second position is situated away from the first position in the direction in which the primary shaft portion extends by a distance corresponding to one half of a length of the diagonal of each of the plurality of pixels.

15. The image display unit according to claim 14, wherein
the first acting portion and the second acting portion are capable of moving the holding portion such that the image display device reciprocates between the first position and the second position in a cycle depending on a frame rate of an image displayed by the image display device.

16. The image display unit according to claim 1, wherein
the first acting portion includes a piezoelectric element.

17. The image display unit according to claim 1, wherein
the second acting portion includes a plate spring.

18. The image display unit according to claim 5, wherein
the pressing portion includes a coil spring.

19. The image display unit according to claim 1, further comprising a sleeve that is movably coupled to the primary shaft portion, wherein
the holding portion is connected to the primary shaft portion through the sleeve.

20. A projector comprising:
an image display device;
a projection section that includes a plurality of lenses and projects an image generated by the image display device;
a primary shaft portion that extends in a direction;
a holding portion that holds the image display device, and is connected to the primary shaft portion to be movable in parallel with the direction in which the primary shaft portion extends;
a first acting portion that is capable of moving the holding portion in a first direction extending in parallel with the direction in which the primary shaft portion extends;
a second acting portion that is capable of moving the holding portion in a second direction that is opposite to the first direction extending in parallel with the direction in which the primary shaft portion extends; and
a control section that is capable of controlling an image display operation performed by the image display device, and is capable of controlling at least one of an operation of moving the holding portion that is performed by the first acting portion, or an operation of moving the holding portion that is performed by the second acting portion, wherein
the first acting portion and the second acting portion are capable of moving the holding portion such that the image display device reciprocates between the first position and the second position in a cycle depending on a frame rate of an image displayed by the image display device.
